(19) United States
(12) Patent Application Publication
(10) Pub. No.: US 2012/0322030 A1
(43) Pub. Date: Dec. 20, 2012

(54) MODULAR ABUTMENT SYSTEM FOR TILTED DENTAL IMPLANTS

(75) Inventor: Ophir Fromovich, Hod Hasharon (IL)

(73) Assignee: ALPHA BIO TEC LTD., Petach Tikva (IL)

(21) Appl. No.: 13/062,714

(22) PCT Filed: Feb. 17, 2011
(86) PCT No.: PCT/IB2011/050670

§ 371 Date: Mar. 8, 2011

Related U.S. Application Data
(60) Provisional application No. 61/305,563, filed on Feb. 18, 2010.

(51) Int. Cl. A61C 8/00

(52) U.S. Cl. 433/173

(57) ABSTRACT

A modular abutment system for offsetting an angle of tilted dental implants in a manner preserving structural stability of restoration components throughout the life of the restoration. A specialized deployment tool configurable to enable a practitioner to utilize available workspace during deployment.

### FIELD AND BACKGROUND OF THE INVENTION

The present invention relates generally to tilted dental implants, and particularly, includes several aspects each believed to be patentable in its own right that together form a particularly advantageous synergy.

Regarding a first aspect of the present invention, it is also known that when dental-implants are implanted at a tilt, i.e. angles other than 90° relative to the crestal bone surface, the associated abutment surfaces necessarily assume a corresponding orientation thereby requiring specialized hardware, equipment, and techniques to construct abutment surfaces suitable for connecting dental prosthetics, overdentures and bridges. The present invention is directed at offsetting the abutment angle resulting from the angle of implant enabling so that a practitioner may employ of standard techniques and equipment. This equipment includes screw-retained, bar-retained, cement-retained, ball or LOCATOR® attachments and other ball or LOCATOR® type attachments for prosthetic restoration based on “all-on 4”, “all-on-6”, and other restoration techniques.

Regarding the second aspect of the present invention, it is know that any restoration must, maintain its structural integral in the face of large forces generated by mastication. It is therefore advantageous to distribute these forces between abutment elements in a manner preserving their structural integrity throughout the product life while installed in the patient. Furthermore, at component interfaces there exists a tendency of micro-movements between system elements. These movements interfere with the regeneration of connective tissue required for complete healing and, over a prolonged period of time, can give rise to component shift thereby reducing the integrity of the associated dental prostheses or bridges. U.S. Pat. No. 4,934,935 discloses a modular abutment system for providing an abutment surface orientated into desired position; however, the system does not disclose any provision for adding structural integrity or reducing component shift, therefore there is a need for a secured modular abutment system.

Regarding the third aspect of the present invention relates, it is known that the limited workspace in a patient's mouth complicates maneuvering deployment of abutment hardware into an implanted, dental implant. The third aspect of the present invention is a deployment tool designed to adjust to the available work space inside the patient's mouth and an unobstructed line of vision during deployment.

### SUMMARY OF THE INVENTION

The present invention is a modular abutment system for offsetting implant angles of tilted, implanted dental implants in a manner reducing component movement throughout the life of the restoration. An abutment body is deployed by way of a deployment tool configurable to best utilize additional available workspace for the practitioner during deployment.

According to the teachings of the present invention there is provided, n abutment device for a dental implant, which includes: (a) an abutment body having a recess circumscribed by a wall having a rim and a circumferential ledge around its inner surface; and (b) an abutment-body cover having a lip configured to be receive by the ledge so that when the lip is supported by the ledge, a top surface of the lip and the rim form a coplanar, combined abutment surface for final abutment in abutment with the combined abutment surface, thereby distributing forces acting on the final abutment between the abutment body and the abutment-body cover.

According to a further feature of the present invention, each abutment body includes a base having a longitudinal bore, the base being connected to the wall, the wall being orientated such that a first central axis of the recess circumscribed by the wall and a second central axis of the bore form an angle of intersection, the angle of intersection defining a corrective abutment angle offsetting a tilt angle of a dental implant implanted at a tilt when attached to the dental implant

According to a further feature of the present invention, the corrective abutment angle of the abutment body is selected from the group consisting of 10°, 17°, 30° and 45°, the abutment body being interchangeably mountable on the dental implant.

According to a further feature of the present invention, the abutment-body cover is selected from the group consisting TCT cover, ball cover, TSA cover, TLAS cover, and Zest LOCATOR® cover; the abutment-body cover being interchangeably mountable on the abutment body.

According to a further feature of the present invention, there is also provided a connection collar attached to an implant end of the abutment-body base, the connection collar having a plurality of circumferentially disposed engagement surfaces for engaging corresponding surfaces of a recess in a dental implant in which the abutment-body is at least partially seated.

According to a further feature of the present invention, the plurality of circumferentially disposed engagement surfaces includes six surfaces.

There is also provided according to the teachings of the present invention, an abutment device for a dental implant, which includes: (a) an abutment body having a recess circumscribed by a wall having a rim and a circumferential ledge around its inner surface; and (b) an abutment-body cover having a lip configured to be received by the ledge so that when the lip is supported by the ledge, a top surface of the lip and the rim form a contiguous, combined abutment surface for an abutting final abutment, thereby reducing the tendency for unscrewing resulting from mastication forces.

According to a further feature of the present invention, the abutment body includes a base having a longitudinal bore, the base being connected to the wall, the wall being orientated such that a first central axis of the recess circumscribed by the wall and a second central axis of the bore form an angle of intersection, the angle of intersection defining a corrective abutment angle offsetting a tilt angle of a dental implant implanted at a tilt when attached to the dental implant.

According to a further feature of the present invention, the corrective abutment angle of the abutment body is selected from the group consisting of 10°, 17°, 30° and 45°, the abutment body being interchangeably mountable on the dental implant.

According to a further feature of the present invention, the abutment-body cover is selected from the group consisting TCT cover, ball cover, TSA cover, TLAS cover, and Zest LOCATOR® cover; the abutment-body cover being interchangeably mountable on the abutment body.

According to a further feature of the present invention, there is also provided a connection collar attached to an implant end of the abutment-body base, the connection collar having a plurality of circumferentially disposed engagement surfaces for engaging corresponding surfaces of a recess in a dental implant in which the abutment-body is at least partially seated.

According to a further feature of the present invention, the plurality of circumferentially disposed engagement surfaces includes six surfaces.

There is also provided according to the teachings of the present invention, an abutment-body holder for holding an abutment body of a dental implant, which includes: (a) a flexible, elongated handle; and (b) a holding element disposed on a distal end of the handle, the holding element having a connection configuration configured to hold an abutment body having a corresponding connection configuration, thereby enabling a user to bend the handle into an orientation facilitating deployment of the abutment body in an implanted dental implant.

According to a further feature of the present invention, the connection configuration includes a thread arrangement.

According to a further feature of the present invention, the holding element has a passageway disposed therein so as to provide screwdriver access to a fixation screw disposed in the abutment body.

According to a further feature of the present invention, the abutment-body holding element includes a retaining protuberance disposed in the passageway so as to block the fixation screw from dislodging from the abutment body.

There is also provided according to the teachings of the present invention, a method of deploying an abutment body in an implanted dental implant comprising: (a) providing a abutment body holder having a flexible, elongated handle; (b) bending the handle for facilitating deployment of the abutment-body into an implanted dental implant; and (c) placing the abutment body held by the abutment-body holder into the implanted dental implant.

According to a further feature of the present invention, there is also provided screwing a fixation screw into the implanted dental implant while the abutment body is being held by the abutment body holder.

There is also provided according to the teachings of the present invention, a method for securing a fixation screw inside an abutment body prior to deployment, which includes: (a) providing an abutment-body holder having: (i) a holding element configured to hold an abutment body and to allow passage of a screwdriver through the holder to engage a fixation screw disposed in an abutment body held by the holder, and (ii) a retaining structure configured to block the fixation screw from dislodging from the abutment body when held by the holder; and (b) connecting the abutment-body holder to the abutment body having a fixation screw disposed inside the abutment body, thereby blocking the fixation screw from dislodging from the abutment body.

According to a further feature of the present invention, the retaining structure includes a protuberance.

According to a further feature of the present invention, the retaining structure includes a passageway having diameter so at to enable passage of a screwdriver and to prevent passage of the fixation screw.

### BRIEF DESCRIPTION OF THE DRAWINGS

The invention is herein described, by way of example only, with reference to the accompanying drawings, wherein:

FIG. 1 is an isometric, side-view of a complete dental-implant assembly including a dental implant, an angular abutment body with its TCT cover.

FIG. 2 is an isometric, side-view of an angular-abutment body.

FIG. 3 is an isometric, side view of a TCT cover.

FIG. 4 is a schematic, cross-sectional, side-view of a complete dental implant assembly depicting abutment hardware in a state of abutment with a combined abutment surface formed by an abutment body unit and a “TCT” cover.

FIGS. 5 and 5A are enlarged views of two embodiments of the area designated “A” of FIG. 4.

FIG. 6 is an isometric, side-view of a tapered-screw-retained, “TCT” cover.

FIG. 6a is an isometric, side-view of a standard-screw-retained “TSA” cover.

FIG. 7 is an isometric, side-view of a ball cover having spherical-support-structure.

FIG. 8 is an isometric, side-view of a “Zest LOCATOR®” cover.

FIG. 9 is an isometric, side view of a cement retained “TLAS” cover.

FIG. 10 is an isometric side view of an abutment-body holding tool holding an angular abutment-body with a fixation screw disposed inside.

FIGS. 11-13 depict an angular, abutment-body held by the holder during various deployment stages in an implanted implant.

FIGS. 14 and 15 are schematic, cross-sectional side-views of the holder of FIG. 10 depicting a retaining protuberance preventing dislodgment of a fixation-screw disposed in the angular abutment-body prior to deployment in an implant.

### DESCRIPTION OF THE PREFERRED EMBODIMENTS

The present invention is a modular abutment system for offsetting implant angles of tilted, implanted dental implants in a manner preserving structural integrity of system components and reducing component shift. The principles and operation of the method according to the present invention may be better understood with reference to the drawings and the accompanying description.

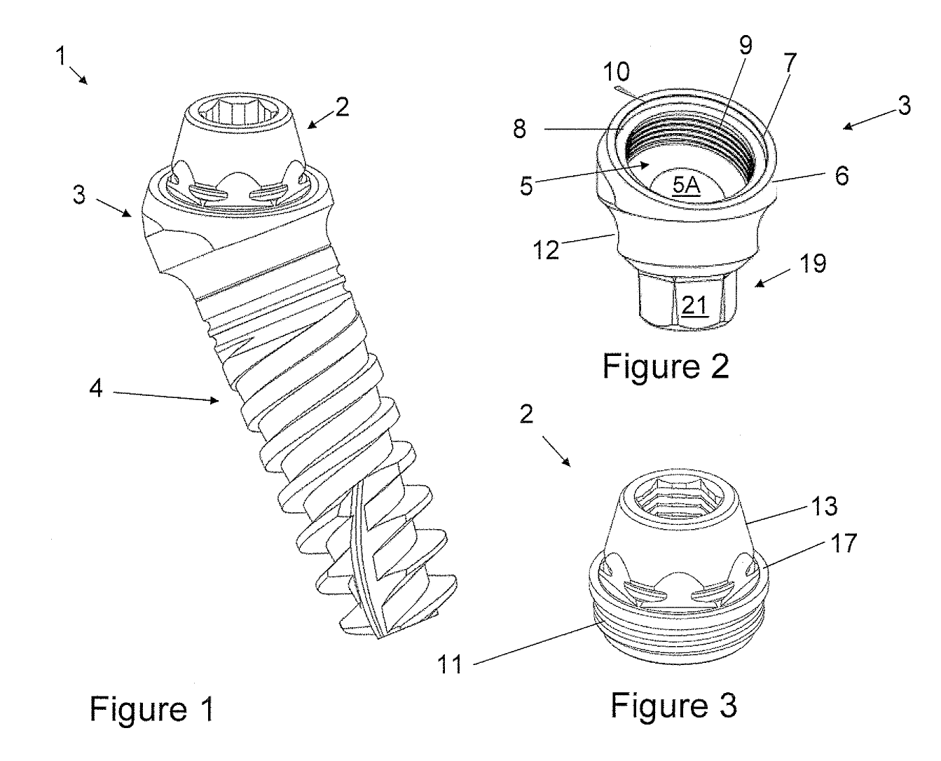

FIG. 1 depicts a complete dental abutment-implant assembly, generally designated 1, including an angular-abutment body 3 connected to dental implant 4 and an abutment cover 2, in turn, that is connected to angular-abutment body 3.

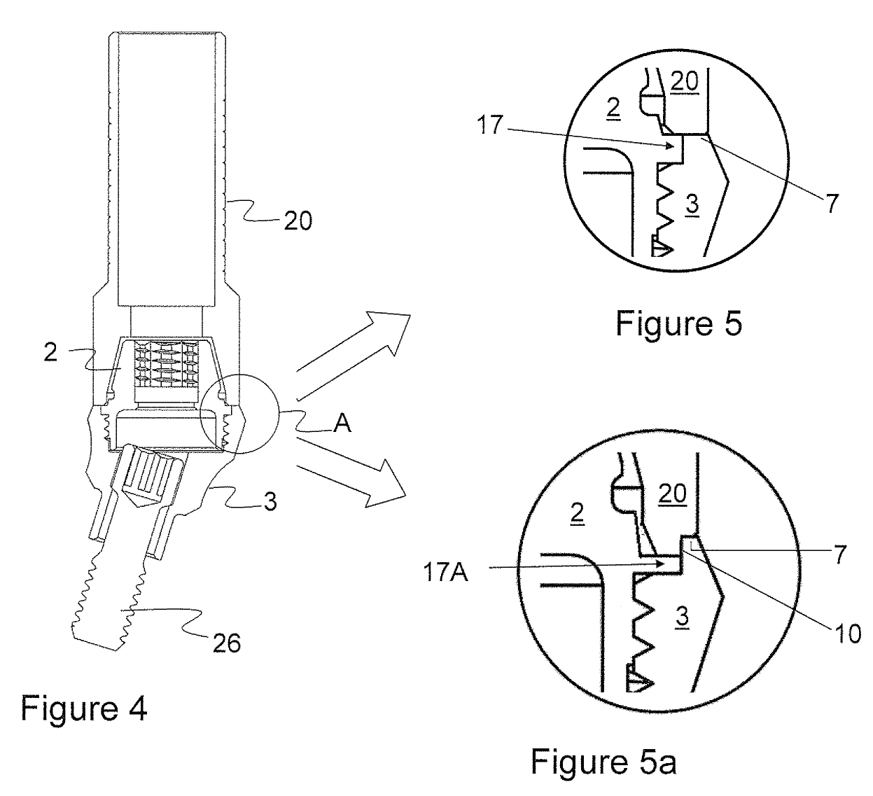

FIG. 2 depicts angular-abutment body 3 that includes a wall 6 circumscribing a recess 5 for receiving cover 2 as will be discussed, base 12 integrally connected to wall 6, a connection collar 19 integrally connected to the implant end of base 12. Longitudinal bore 5A traverses base 12 and connection collar 19 to enable a fixation screw 26 (FIG. 4) to pass through abutment body 3 to secure it to dental implant 4 as will be further discussed. Wall 6 is integrally connected to base 12 at an angle defined by an angle of intersection between the central axis defined by wall 6 and the central axis defined by base 12. This angle defines the abutment angle unique to each angular-abutment body 3, for offsetting a corresponding angle of implant tilt of dental implant 4 so that an abutment surface of cover 2 or of a combined abutment surface formed by cover 2 and body 3 is orientated to the necessary angle for final restoration as is known by practitioners skilled in the art. In non-limiting, preferred embodiments the angular-abutment bodies 3 are provided with any one of possible abutment angles. Non-limiting, exemplary abutment angles include 10°, 17°, 30°, or 45°; however, it should be appreciated that angular-abutment bodies 3 having any abutment angle is included within the scope of the present invention. As mentioned above, each angular-abutment body 3 is interchangeably mountable on dental implant 4 thereby advantageously enabling a practitioner during deployment to mount the selected angular-abutment body 3 to a previously implanted implant 4. The particular angular-abutment body 3 is selected so that its angle counteracts the angle of tilt at which implant 4 is implanted thereby enabling the practitioner to connect the preferred cover required for the particular restoration at hand using equipment and techniques normally employed during restoration utilizing non-tilted, dental implantations. It should be appreciated that an angular abutment body is discussed throughout the document; however, non-angular abutment bodies are also included within the scope of the invention in regards to the features directed towards the combined abutment surface and flexible deployment tool.

Wall 6 includes a circumferential inner ledge 8, an inner threading 9 corresponding to outer threading of abutment cover body 11, and rim 7 for supporting cover 2 when mounted on abutment body 3.

FIG. 3 depicts an abutment cover 2 having a frustum shaped abutment structure 13 integrally connected to an externally threaded body 11. Circumferential flange 17 is disposed at the base of frustum shaped abutment structure 13.

FIG. 4 is a cross-sectional view of an assembly of abutment body 3, abutment cover 2, final abutment 20 and fixation screw 26. FIGS. 5-5a are enlarged views of the abutment surfaces of abutment body 3, abutment cover 2 and final abutment 20. As most clearly shown in FIG. 5, when abutment cover 2 is screwed into abutment body 3, circumferential flange 17 abuts against ledge 8 of abutment body 3 and the top surface of circumferential flange 17 and rim 7 are coplanar so as to form a combined abutment surface for final abutment 20. This arrangement advantageously distributes mastication forces acting on final abutment 20 between abutment body 3 and abutment cover 2 thereby reducing the tendency of abutment-cover 2 to unscrew from abutment-body 3. The stability of the abutment configuration is crucial to proper healing and preservation of the restoration throughout the product life.

FIG. 5a depicts an alternative, non-limiting embodiment essentially analogous to the above described embodiment of FIG. 5 with the exception of the thickness of circumferential flange 17A of abutment cover 2. Circumferential flange 17A has a reduced thickness so that when abutting ledge 8, the top surface is non-planar, but still contiguous, with rim 7. Final abutment 20 has a corresponding step enabling abutment with rim 7 of abutment body 3 and the top surface of reduced thickness flange 17A of abutment cover 2 thereby distributing forces between abutment body 3 and abutment cover 2 as described above. Furthermore, the step of final abutment 20 provides an additional surface for abutment with the inner wall 10 of abutment body 3 to further secure abutment cover 2, abutment body 3 and final abutment 20 firmly in place.

As mentioned above, abutment body 3 includes connection collar 19 attached to the implant end of abutment body 3 as shown in FIG. 2. Connection collar 19 includes a plurality of circumferential engagement surfaces 21 for engaging corresponding surfaces formed in the wall of a recess of dental implant 4. When abutment body 2 is at least partially seated in the implant recess the corresponding engagement surfaces engage and prevent rotation of abutment body 2. It should be noted that in a non-limiting, exemplary embodiment, connection collar 19 includes six engagement surfaces; however, it should be appreciated that connection collars having any number of engagement surfaces or any other non-rotational structure are included within the scope of the present invention.

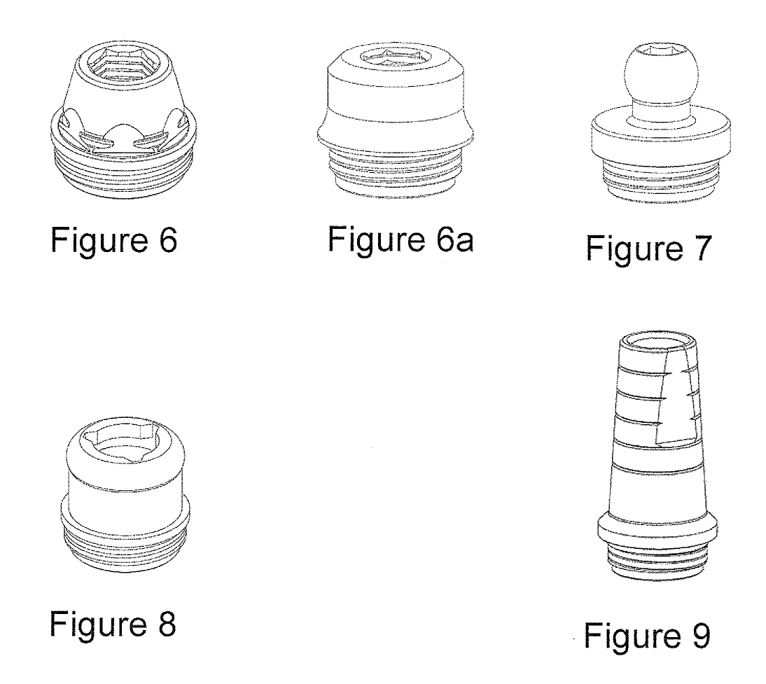

FIGS. 6-9 depict various, interchangeably mountable abutment covers, each having a differing abutment surface geometries to meet the needs of the particular restoration at hand. Particularly, FIG. 6 depicts a TCT cover having a frustum shaped abutment structure as described above. FIGS. 6a, 7, 8, and 9 depict TSA cover, a ball cover, a Zest LOCATOR® cover, and a TLAS cover, respectively. It should be noted that any cover having a connection configuration enabling interchangeable mounting on abutment body 3 is included within the scope of the present invention. Furthermore, it should be appreciated that any cover type having a circumferential flange or equivalent structure forming a combined abutment surface with rim 7 when mounted on abutment body 3 is included within the scope of the present invention. In a non-limiting, exemplary embodiment, abutment bodies, covers, and dental implants are constructed from titanium; however, it should be appreciated that any other metal, metallic alloy, ceramic material exhibiting appropriate durability and biocompatibility are suitable candidates for construction materials. The abutment bodies, covers, and dental implant are manufactured by machining or other relevant manufacturing processes as is known in the art.

As mentioned above, the present invention also relates to an abutment body deployment tool. The deployment of the small abutment components in the limited work space of a patient's mouth creates difficulty work conditions for a practitioner. A physician, for example, needs to place abutment body 3 inside an implant recess of an implanted dental implant 4, insert fixation screw 26 and then screwdriver 27 into abutment body bore 5A through passageway 29, and then tighten fixation screw 26 to secure abutment body 3 to implant bore 4. In a non-limiting embodiment, screw 26 is pre-inserted in the assembly of the body 3 and holder 22. To successfully execute these delicate operations the physician needs sufficient work space and a clear line of vision; without them, there is a danger of abutment body 3 or fixation screw 26 falling into the mouth of the patient. This can lead to inadvertent swallowing or added discomfort caused by the physician attempting to recover the fallen components. Existing abutment-body holders alleviate the problem only partially because their rigid handles consume precious work space and can interfere with the line of sight of the physician. The present invention addresses this shortcoming as will be discussed.

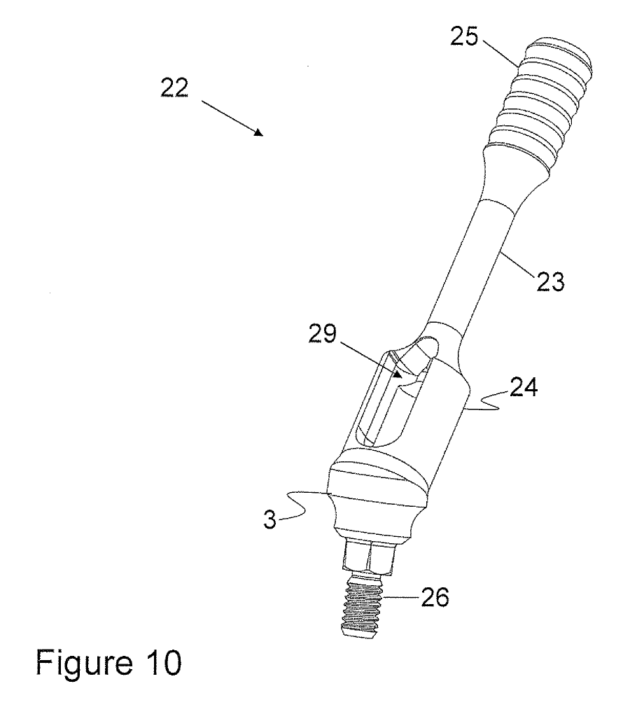

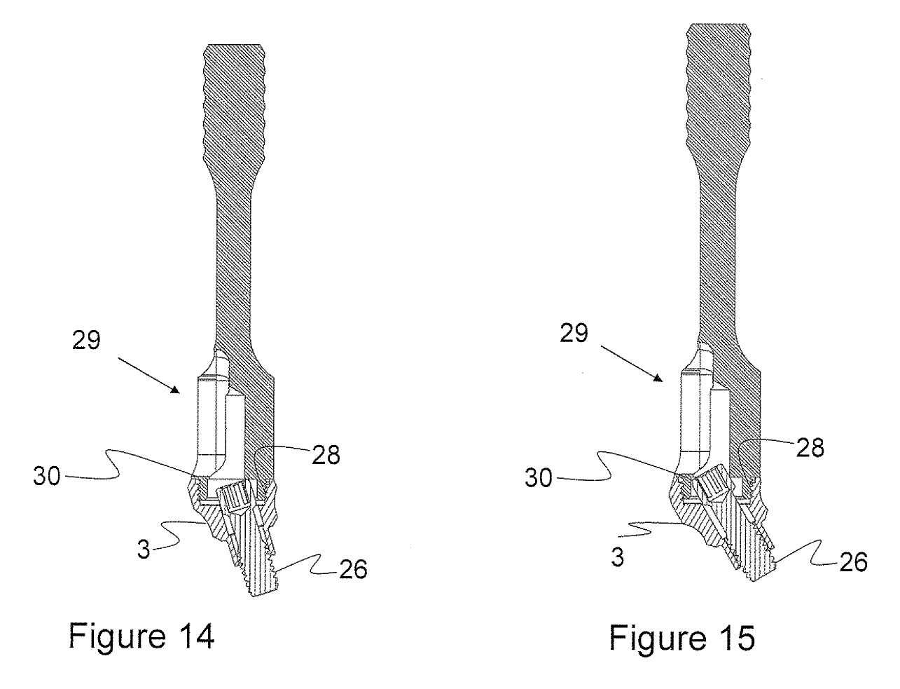

FIG. 10 depicts an abutment-head holder 22 that includes an elongated, flexible handle 23 with a grip 25 on the proximal end and a holding element 24 connected to the distal end. In an exemplary, non-limiting embodiment, the distal, outer surface of holding element 24 is threaded with a thread arrangement 28 corresponding to the inner threading 9 (FIG. 2) of angular-abutment body 3 as is most clearly seen in the cross-sectional views of FIGS. 14 and 15. It should be appreciated that any connection configuration enabling releasable attachment and re-attachment is included within the scope of the present invention. In a non-limiting exemplary embodiment, grip 25 has an enlarged diameter and a textured surface to facilitate comfortable and effective gripping to reduce the likelihood of holder 22 slipping from the hand of the physician during deployment in hard-to-access portions of the mouth. In a non-limiting, exemplary embodiment, the diameter of grip 25 is 3.5 millimeters and handle 23 has a diameter of 1.9 millimeter. Holding element 24 includes a passageway 29 providing screwdriver access to fixation screw 26 disposed inside angular-abutment body 3 in preparation for deployment into implanted implant 3. In a non-limiting, exemplary embodiment, angular-abutment body 3 and fixation screw 26 are factory pre-assembled as described in preparation for deployment in an implanted dental implant 4.

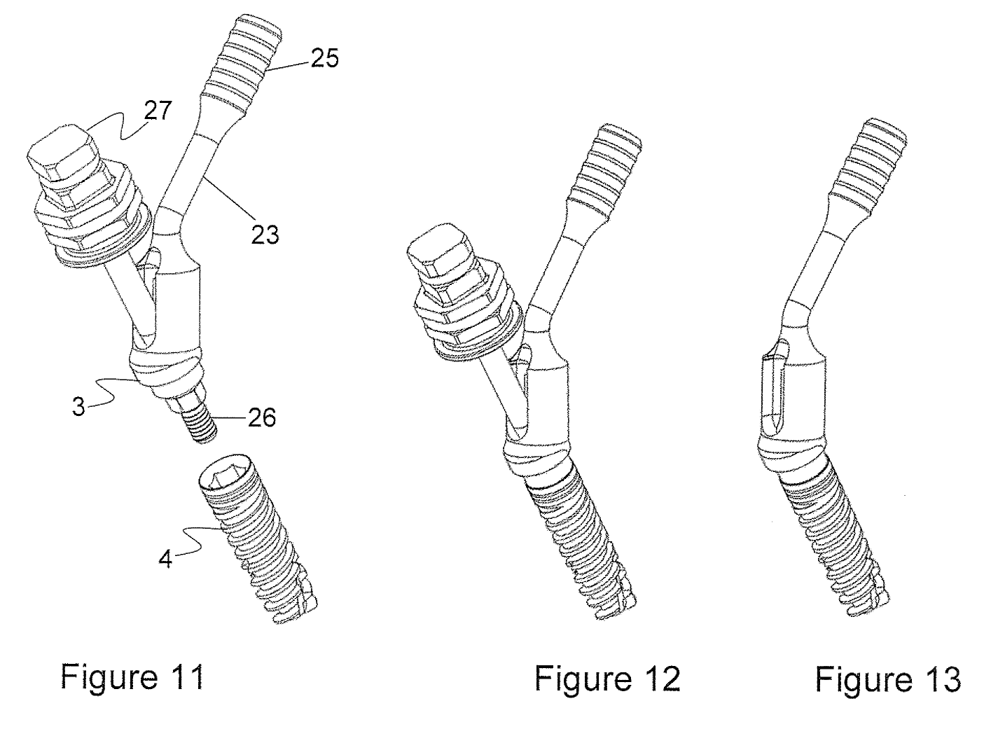

FIGS. 11-13 depict various stages of deployment of angular-abutment body 3 into dental implant 4. Upon deployment of the partially, pre-assembled angular-abutment body 3 in implanted dental implant 4, a physician (or any other practitioner) bends handle 23 into a position providing maximum work space and an unobstructed line of vision and engages fixation screw 26 by way of screwdriver 27 inserted through passageway 29. The practitioner directs angular-abutment body 3 and fixation screw 26 into the corresponding bore and recess of dental implant 4 by way of holder 22 and secures angular-abutment body 3 into place by tightening fixation screw 26. The practitioner then retracts screwdriver 27, unscrews holder 22 from angular-abutment body 3 and discards holder 22. It should be noted that non-disposable or multi-use holding devices are also included within the scope of the present invention. It should also be appreciated that mechanical designs facilitating bending handle 23 at any point of the deployment process is included within the scope of the present invention.

As is known in the art, dental implant suppliers frequently deliver the systems partially assembled with fixation screw 26 disposed in angular-abutment body 3 to simplify deployment, minimize losses of small system components, and also minimize the chances of contamination resulting from handling by practitioners. However, the rough handling and jarring of the system during shipping or during deployment of the abutment in the patient mouth frequently dislodges fixation screw 26 from their pre-disposed placement inside abutment body 3. As mentioned above, this can lead to patient discomfort when recovering the fallen fixation screw 26 and re-inserting it into bore 5 within angular-abutment body 3 or even lead to inadvertent swallowing of the fixations screw 26 by the patient. The present invention also addresses this irritant and potential danger by providing a retaining protuberance 30 disposed inside passageway 29 as shown in FIGS. 14 and 15. Retaining protuberance 30 is offset from the central axis of passageway 29 so, as to allow driver access to fixation screw 26 disposed in angular-abutment body 3, and to block fixation screw 26 from totally dislodging from angular-abutment body 3. It should be noted embodiments having a passageway whose diameter allows driver access to fixation screw 26 and blocks the passage fixation screw 26 are also included in the scope of the present invention.

In a non-limiting, exemplary embodiment, abutment-body holder 22 is constructed from stiff, but flexible, plastic material such as PBT, PET, Delrin® or other comparable materials known to those skilled in the art and manufactured by molding or other techniques normally employed in the art or any other material.

It will be appreciated that the above descriptions are intended only to serve as examples, and that many other embodiments are possible within the scope of the present invention as defined in the appended claims.

1. An abutment device for a dental implant, which comprises:
(a) an abutment body having a recess circumscribed by a wall having a rim and a circumferential ledge around its inner surface;
(b) an abutment cover having a lip configured to be received by said ledge so that when said lip is supported by said ledge, a top surface of said lip and said rim form a combined abutment surface; and
(c) a final abutment for deployment in abutment with said combined abutment surface,
wherein said abutment body, said abutment cover and said final abutment are arranged such that, when said abutment cover is attached to said abutment body and said final abutment is attached, a central portion of said final abutment is spaced from said abutment cover and forces acting on the final abutment are distributed between said rim of said abutment body and said lip of said abutment cover.

2. The abutment device of claim 1, wherein each of said at least one abutment body includes a base having a longitudinal bore, said base being connected to said wall, said wall being orientated such that a first central axis of the recess circumscribed by said wall and a second central axis of the bore form an angle of intersection, the angle of intersection defining a corrective abutment angle offsetting a tilt angle of a dental implant implanted at a tilt when attached to the dental implant.

3. The abutment device of claim 2, wherein said corrective abutment angle of said abutment body is selected from the group consisting of 10°, 17°, 30° and 45°, said abutment body being interchangeably mountable on said dental implant.

4. The abutment device of claim 1, wherein said abutment-body cover is selected from the group consisting TCT cover, ball cover, TSA cover, TLAS cover, and Zest LOCATOR® cover; said abutment-body cover being interchangeably mountable on said abutment body.

5. The abutment device of claim 1, further comprising a connection collar attached to an implant end of said abutment-body base, said connection collar having a plurality of circumferentially disposed engagement surfaces for engaging corresponding surfaces of a recess in a dental implant in which said abutment-body is at least partially seated.

6. The abutment device of claim 5, wherein said plurality of circumferentially disposed engagement surfaces includes six surfaces.

7. An abutment device for a dental implant, which comprises:
(a) an abutment body having a recess circumscribed by a wall having a rim and a circumferential ledge around its inner surface; and
(b) an abutment-body cover having a lip configured to be received by said ledge so that when said lip is supported by said ledge, a top surface of said lip and said rim form a contiguous, combined abutment surface for an abutting final abutment, thereby reducing the tendency for unscrewing resulting from mastication forces.

8. The abutment device of claim 7, wherein said abutment body includes a base having a longitudinal bore, said base being connected to said wall, said wall being orientated such that a first central axis of the recess circumscribed by said wall and a second central axis of the bore form an angle of intersection, the angle of intersection defining a corrective abutment angle offsetting a tilt angle of a dental implant implanted at a tilt when attached to the dental implant.

9. The abutment device of claim 8, wherein said corrective abutment angle of said abutment body is selected from the group consisting of 10°, 17°, 30° and 45°, said abutment body being interchangeably mountable on the dental implant.

10. The abutment device of claim 7, wherein said abutment-body cover is selected from the group consisting TCT cover, ball cover, TSA cover, TLAS cover, and Zest LOCATOR® cover; said abutment-body cover being interchangeably mountable on said abutment body.

11. The abutment device of claim 7, further comprising a connection collar attached to an implant end of said abutment-body base, said connection collar having a plurality of circumferentially disposed engagement surfaces for engaging corresponding surfaces of a recess in a dental implant in which said abutment-body is at least partially seated.

12. The abutment device of claim 11, wherein said plurality of circumferentially disposed engagement surfaces includes six surfaces.

13. An abutment-body holder for holding an abutment body of a dental implant, which comprises:
(a) a flexible, elongated handle; and
(b) a holding element disposed on a distal end of said handle, said holding element having a connection configuration configured to hold an abutment body having a corresponding connection configuration, thereby enabling a user to bend said handle into an orientation facilitating deployment of the abutment body in an implanted dental implant.

14. The abutment-body holder of claim 13, wherein said connection configuration includes a thread arrangement.

15. The abutment-body holder of claim 14, wherein said holding element has a passageway disposed therein so as to provide screwdriver access to a fixation screw disposed in the abutment body.

16. The abutment-body holder of claim 15, wherein said abutment-body holding element includes a retaining protuberance disposed in said passageway so as to block the fixation screw from dislodging from said abutment body.

17. A method of deploying an abutment body in an implanted dental implant comprising:
(a) providing an abutment-body holder having a flexible, elongated handle;
(b) bending said handle for facilitating deployment of said abutment-body into an implanted dental implant; and
(c) placing said abutment body held by said abutment body holder into the implanted dental implant.

18. The method of claim 17, further comprising screwing a fixation screw into the implanted dental implant while the abutment body is being held by said abutment body holder.

19. A method for securing a fixation screw inside an abutment body prior to deployment, which comprises:
(a) providing an abutment-body holder having:
(i) a holding element configured to hold an abutment body and to allow passage of a screwdriver through the holder to engage a fixation screw disposed in an abutment body held by the holder, and
(ii) a retaining structure configured to block the fixation screw from dislodging from said abutment body when held by the holder; and
(b) connecting said abutment-body holder to the abutment body having a fixation screw disposed inside the abutment body, thereby blocking the fixation screw from dislodging from the abutment body.

20. The method of claim 19, wherein said retaining structure includes a protuberance.

21. The method of claim 20, wherein said retaining structure includes a passageway having diameter so at to enable passage of a screwdriver and to prevent passage of the fixation screw.

22. The abutment device of claim 1, wherein said top surface of said lip and said rim form a combined coplanar abutment surface.
